(19) United States
(12) Patent Application Publication
(10) Pub. No.: US 2014/0074665 A1
(43) Pub. Date: Mar. 13, 2014

(54) MARKETPLACE FOR THE SALE OF GOODS AND SERVICES WHEREBY SALE PROCEEDS ARE PROVIDED TO CHARITABLE ORGANIZATIONS

(71) Applicant: John Stewart, Roseneath (CA)

(72) Inventor: John Stewart, Roseneath (CA)

(21) Appl. No.: 13/611,832

(22) Filed: Sep. 12, 2012

(51) Int. Cl. G06Q 30/06

(52) U.S. Cl. 705/27.1

(57) ABSTRACT

An online system and service that enables charities to receive and encourage donations through donors selling items, such as goods or services, in exchange for a charitable receipt from the charity. The system enables a seller to post an item for sale and for buyers to buy the item for sale at fair market value (FMV). The seller can designate one or more charities to receive all or a portion of the monetary proceeds from the sale. Through a filtering system the items are searchable by a number of criteria, including: charity, price, seller, recency of posting, etc.

### TECHNICAL FIELD

The present invention relates to computer-implemented marketplaces for the sale of goods and services whereby the sale proceeds are provided to charitable organizations, and the like.

### BACKGROUND OF THE INVENTION

Today, charities rely on cash or cash-equivalent donations for the majority of their fundraising efforts. With the downward turn in the economy, charities have found it increasingly difficult to obtain new donations and sustain repeat funding from current donors. Finding new donors has become increasingly challenging.

Yet donors might be interested in gifting a good or service they can provide to a charity, rather than money. To convert that gift into a monetary donation for the charity, the good or service has to be sold by the donor or the charity. In other words, the proceeds of the sale of that good or service are donated to the charity. However, having to sell a good or service may be too time-consuming or challenging in some way for the would-be donor or charity.

Therefore, there is a need for a marketplace for the sale of goods and services by donors whereby the sale proceeds are donated to charitable organizations, and the like.

### SUMMARY OF INVENTION

The present invention provides an online system and service that enables charities to receive and encourage donations through donors selling items, such as goods or services, in exchange for a charitable receipt from the charity. The system enables a seller to post an item for sale and for buyers to buy the item for sale at fair market value (FMV). The seller can designate one or more charities to receive all or a portion of the monetary proceeds from the sale. Through a filtering system the items are searchable by a number of criteria, including: charity, price, seller, recency of posting, etc.

According to the present invention, the marketplace offers each charity a unique web portal page. Through its page(s), the charity is able to specifically target users, and its identified donors, for a specific fundraising goal. Its donors are driven to its page through marketing campaigns, electronic or otherwise. An email campaign is a possible way to drive donors to its page. The charity's page will also include a listing of all items being sold on behalf of its charity. As such, buyers that would like to support the charity are encouraged to buy goods that will benefit their charity of choice.

The present invention also contemplates that each seller will have a portal page. Its page(s) will enable the seller to view all of its items for sale, to initiate alerts to others about particular items for sale, to also edit the item or service, generate an automatic URL for each seller's item page that can be then shared on the web or via social media, and a deletion function, and to maintain historical data on past sales. A direct link from the charity's website to the portal page is also contemplated.

Once a buyer has paid for the item, the charity is paid a portion of or the total amount of the monetary proceeds from the sale. A number of payment processing means are contemplated for compensating the charity. The seller then receives a tax receipt equivalent to the monetary proceeds directed to the charity. A number of shipping or delivery methods are contemplated.

A mobile application is also contemplated that enables users to post items online. A mobile device with a built-in camera can be utilized to take pictures of the items to be sold by the seller.

In a first aspect, the present invention provides a system for managing charitable donations of goods and services from a donor to a charity, the system comprising:
a donation management module for receiving and presenting information on a donation from a donor, said donation management module also being for associating said donation to a specific charity such that in the event said donation is sold to a buyer, at least a portion of proceeds from a sale of said donation is sent to said charity;
a payment management module for managing a payment from said buyer purchasing said donation, said payment management module also being for transferring said portion of proceeds to said specific charity once said donation has been received by said buyer; and
a database module for managing a database which stores information on said:
   donation,
   payment,
   receipt,
   buyer,
   donor, and
   said charity
      wherein
said database module communicates with said donation management module and said payment management module to send and receive said information;
said donation comprises at least one of: goods and services;
said system is deployed on at least one computer server.

In a second aspect, the present invention provides a method for managing charitable donations of goods and services from a donor to a charity organization, the method comprising:
a) receiving information from a donor regarding a donation;
b) associating said donation with said charity organization;
c) posting said information regarding said donation to a web portal such that said donation is available for purchase;
d) receiving an offer from a buyer to purchase said donation from said donor;
e) receiving payment for said donation;
f) transferring at least a portion of proceeds to said charity once said donation has been received by said buyer;
g) sending said donor a receipt for said donation.

In a third aspect, the present invention provides computer readable media having encoded thereon computer executable instructions which, when executed, implements a method for managing charitable donations of goods and services from a donor to a charity organization, the method comprising:
a) receiving information from a donor regarding a donation;
b) associating said donation with said charity organization;
c) posting said information regarding said donation to a web portal such that said donation is available for purchase;
d) receiving an offer from a buyer to purchase said donation from said donor;
e) receiving payment for said donation;
f) transferring at least a portion of proceeds to said charity once said donation has been received by said buyer.

### BRIEF DESCRIPTION OF THE DRAWINGS

The embodiments of the present invention will now be described by reference to the following figures, in which identical reference numerals in different figures indicate identical elements and in which:

FIG. 1 is a block diagram of a computer-implemented system according to an embodiment of the present invention;

FIG. 2 is a flowchart showing method steps according to an embodiment of the present invention; and

FIG. 3 is a block diagram of modules present in a software system according to another embodiment of the invention.

### DETAILED DESCRIPTION OF THE INVENTION

This document defines a product and a donation as any good or service that may be offered for sale.

The document defines a donor as a seller of any good or service that donates at least a portion of the proceeds of the sale of the good or service to a charitable organization or the like.

The present invention provides an online system and service that enables charities to receive and encourage donations through donors selling items, such as goods or services, and routing the proceeds of the sales to the charities in exchange for a charitable receipt from the charity. The system enables a donor to post an item for sale and for buyers to buy the item for sale at fair market value (FMV). The donor can designate one or more charities to receive all or a portion of the monetary proceeds from the sale. These charities are thus associated with the donation such that when the donation is sold, the funds received are earmarked for transfer to these charities. Through a filtering system, the donations for sale are searchable by a number of criteria, including: charity, price, seller, recency of posting, etc. It should be noted that, for this document, the term “donation” encompasses the goods or services that the donor is selling, for which at least a portion of the proceeds are to be transferred to a charity as a charitable donation.

According to the present invention, the marketplace provides each charity registered with the marketplace a portal page. Through its page(s), the charity is able to specifically target users, potential donors, potential buyers and identified previous donors, for a specific fundraising goal. Its donors are driven to its web page (a unique URL on the World Wide Web) through marketing campaigns, electronic or otherwise. An email campaign is a possible way to drive donors to its page. The charity's page will also include a listing of all items or services being offered for sale with proceeds to be donated to the charity. As such, buyers that would like to support the charity are encouraged to buy goods that will benefit their charity of choice. A direct link from the charity's website to the charity's portal page is also contemplated.

The present invention also contemplates that each donor will have a portal page. A donor's page(s) will enable the donor to view all of his or her items for sale, to initiate alerts to others about particular items for sale, to also edit the item or service, generate an automatic URL for each seller's item page that can be then shared on the web or via social media, and a deletion function, and to maintain historical data on past sales. Preferably, to preserve the donor's privacy, the donor's page(s) will only be accessible to the donor.

It should be noted that a web page for all available donations up for sale is also contemplated. Such a web page can list whatever donations are up for sale, their prices, as well as which charities are earmarked to receive the proceeds. Preferably, the system is only available to registered users. As such, donors and buyers have to register before they can offer donations or before they can view what donations are available for sale. However, it should be noted that, in one implementation, buyers and donors need not register prior to offering donations or prior to viewing what donations are available.

After a donor puts up a donation for sale, a buyer can indicate his or her willingness to purchase the donation. As noted above, a donation is a good or a service put up for sale by the donor with at least a portion of the proceeds to be routed to a charity as a charitable donation. The buyer and the donor can then communicate with each other, either through the online system or by other means, to finalize the purchase. The purchase price can be predetermined (i.e. set by the donor and indicated on the web page) or the purchase price may be what the buyer offers. If the purchase price is what the buyer offers, it is preferred that the donor adjust the price on the online system to the agreed upon price.

Once the buyer and the donor have agreed to the purchase of the donation, the buyer can then pay for the donation using the online system. It is contemplated that the online system will provide the buyer with a number of payment options. Online payment processors such as PayPal™ and other credit card processors may be used. Similarly, electronic funds transfer (EFT) processors, direct bank transfers, and other means of payment may be used. The buyer pays for the donation and the funds, regardless of how the payment is processed, are deposited in an account that holds the payment in escrow. The account may be in the name of the operator or owner of the online system. Once the funds have been received in the account (or once acceptable proof of payment has been received), the online system can notify the donor of the receipt of payment. The donor can then ship, send, perform the service, or otherwise deliver or cause the delivery of the donation to the donor. Of course, if delivery or shipment is necessary, the method of shipment and the costs of shipment are to be previously agreed upon between the donor and the buyer. These costs may be factored in the price for the donation or may be agreed upon by the donor and the buyer.

After the buyer notifies the online system that the donation has been received (in the case of a service, perhaps after the service has been performed), the online system can then release the funds held in escrow to the charity for which the funds have been earmarked. The actual amount sent to the charity or charities may depend on how much needs to be deducted by the online system and what amount was necessary for shipping. As an example, the online system may deduct a 10% fee from the purchase price for facilitating the transaction and further fees may need to be deducted to account for shipping charges. The remaining amount is then routed or transferred to the relevant charity or charities.

After the charity receives the funds, the online system issues, on behalf of the charity or charities which received the funds, a receipt to the donor for the donation which was sold. The amount for the receipt may depend on the amount which the charity actually received. Depending on the configuration and preferences of the online system, the receipt may reflect any amounts deducted by the online system as well as any amounts allocated for shipping.

It should be noted that while the above describes the online system as issuing a receipt for the donation, other implementations are possible. In one configuration, the online system produces periodic reports that detail the donors, their donations, and how much the donation was sold for. These periodic reports are then sent to the various charities and the charities themselves issue the relevant receipts for the donors.

A mobile application is also contemplated for the present invention. The mobile application would enable users to post items online. A mobile device with a built-in camera can be utilized to take pictures of the items to be donated by the donor. The mobile application can be configured such that it provides instant access to a donor's web portal to thereby ease the process of listing a donation for sale. The mobile application can be configured to either select a picture from the mobile device's pre-existing pictures/images or control the built-in camera to receive the picture/image to be taken. The mobile application can also be configured to provide the user with predefined templates, with suitable drop-down menus, to enable the user to quickly and easily list a donation. As an example, a drop-down menu can give the user the option to list a good or a service as a donation. Another drop-down menu can provide the user with options as to which charity or charities to be associated with the donation (i.e. which charity or charities are to receive at least a portion of the proceeds of the sale of the donation).

It should also be understood that the present invention may be implemented using a private or a public network. For example, the system may be online and accessible through the Internet.

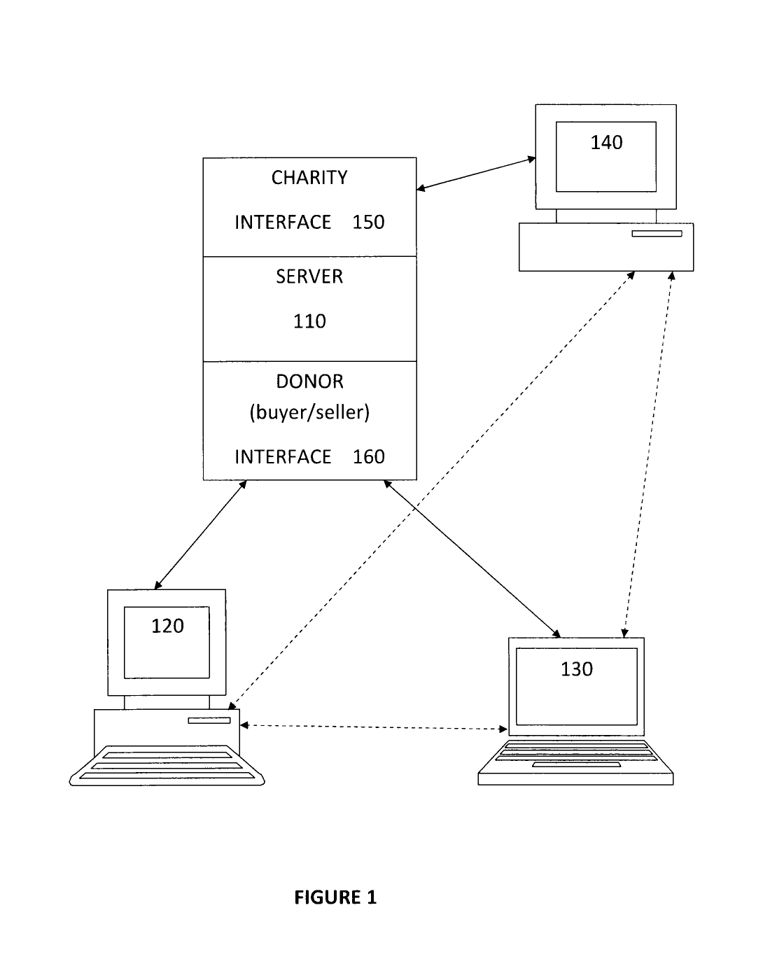

FIG. 1 is a block diagram of a computer-implemented system according to an embodiment of the present invention. The exemplary system 100 comprises a server 110, having internal processing means, memory means, and communication means (not shown). The server 110 also includes at least one user interface component enabling a charitable organization interface 150 and a donor interface 160. Through the server's communication means, the server 110 is in communication with the donor 120, the buyer 130, and the charitable organization 140, as shown through the connecting lines. As noted above, the donor may access the system using an application for a mobile device.

The charity interface 150 and the donor interface 160 may be a combined user interface or two distinct interfaces. For example, the donor 120 and the charity 140 may access the same user interface. However, each registered user—buyer, donor and charity—will have its own individualized profile and user interface page.

As shown in FIG. 1, the donor 120 and the buyer 130 communicate with the server 110 through the donor interface 160, enabled by the at least one interface component (not shown). The charity 140 communicates with the server through the charity interface 150, also enabled by at least one interface component (not shown).

It should be mentioned that a plurality of charities, buyers, and donors are contemplated by the present invention, and that the server 110 may be in communication with each of the plurality of charities, buyers, and donors. However, for visual simplicity, only one donor 120, one charity 140, and one buyer 130 are shown.

It should also be mentioned that the user interface components may not be required in accordance with another embodiment of the present invention. Alternative interfacing with the system and between its users may be contemplated. For example, short message services (SMSs) or electronic mail (e-mail) may be used to communicate marketplace information between any of the users and the system.

In FIG. 1, the dashed lines between the donor 120 and the buyer 130 represent an optional communication means and channel between the seller 120 and the buyer 130. The donor 120 and the buyer 130 may be in direct contact about the donations for sale. For example, the donor 120 may send an e-mail notification directly to the buyer 130 about a product that the buyer 130 may be interested in. This is in contrast to the notification being sent through the communication means of the server 110. The seller 120 may also utilize the communication channel to encourage the buyer 130 to register as a user of the system.

In addition, the dashed lines between the charity 140 and the donor 120 and the buyer 130, respectively, represent an optional communication means and channel between the charity 140 and the donor 120 and the buyer 130, respectively. Through this additional communication channel, the charity 140 may encourage the buyer to join as a registered user of the system. The charity 140 may also utilize the communication channel to coordinate the forwarding of a tax receipt to the donor 120 once the buyer 130 has purchased a product from that particular donor.

It should also be mentioned that registration as a system user, by a charity 140, a donor 120, or a buyer 130 (not required), may be free or a paid subscription. The system server 110 administers the registration.

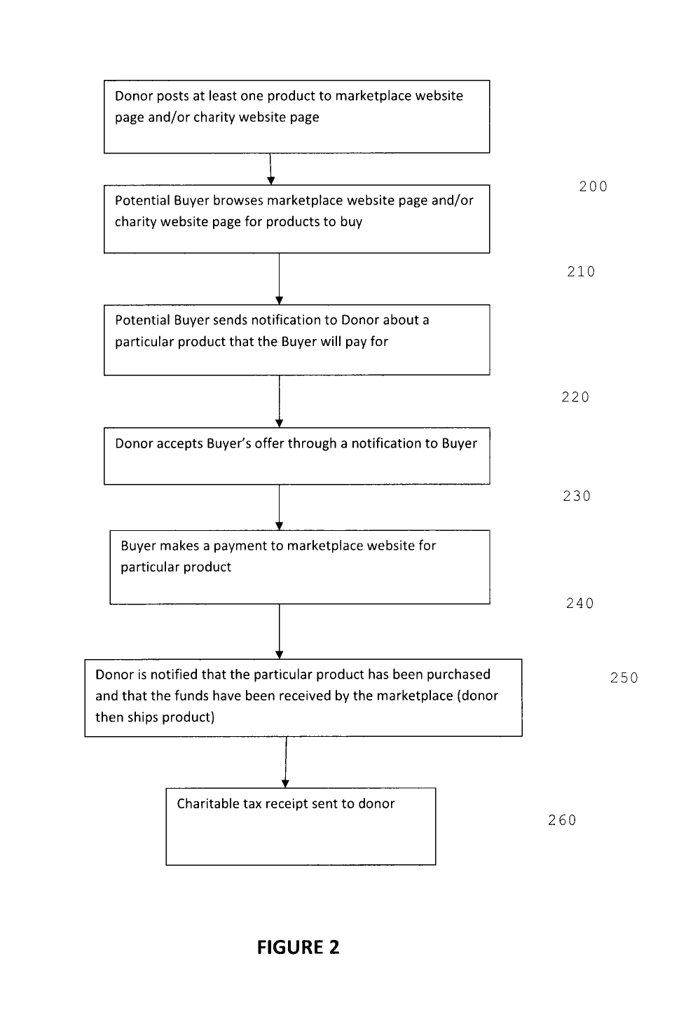

FIG. 2 is a flowchart showing method steps in accordance with an embodiment of the present invention.

As can be seen from FIG. 2, the method starts with the donor posting a donation as being up for sale on the online system or marketplace website (Step 200). The posting can also be on the website/web portal for a particular charity with which the donation has been associated. In step 210, a potential buyer reviews available donations, i.e. donations which are up for sale. Once the potential buyer identifies a donation that he or she is interested in, for step 220, the buyer notifies the donor of the buyer's interest. The donor accepts the buyer's implicit or explicit offer in step 230. As noted above, the buyer may offer a different price for the donation and, if the donor accepts the price, the donor may change the listing.

After the donor and the buyer agree on the sale of the donation, the buyer can then make a payment for the donation (step 240). As noted above, this can be done through any number of payment processors such as PayPal™ or through electronic funds transfer. To facilitate the payment, the online system can offer the buyer multiple payment options and then forward or direct the buyer to the buyer's selected payment option. Once payment has been effected, the online system is notified and this information is then passed to the donor. The donor can then ship, send, or otherwise cause to be delivered the donation that the buyer paid for (step 250). Once delivery has been completed, the online system can then forward a receipt to the donor (step 260).

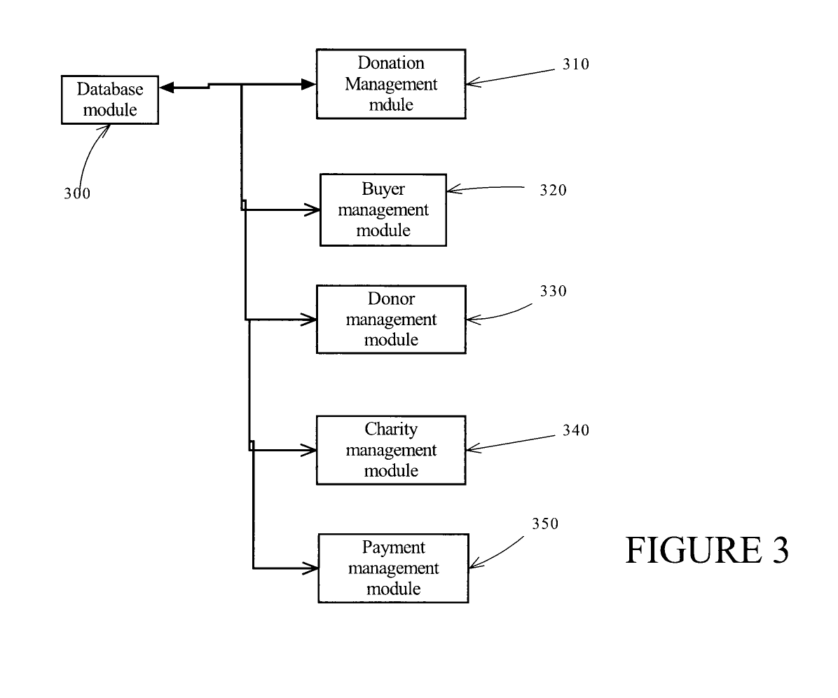

FIG. 3 is a block diagram of a system according to another aspect of the invention. As can be seen, the system in FIG. 3 has a number of software modules which interact with one another and which, as a whole, performs the functions described above. The system in FIG. 3 has a database module 300 that manages a database containing information regarding the registered charities, registered donors, registered buyers, the donations previously sold, the donations currently available, and past and present payment data. The database module ensures that the data is managed properly and is properly stored on the magnetic or optical media on the server.

Another module in the system is the donation management module 310. The donation management module 310 receives information regarding incoming donations, including donor identification, preferred donor price, preferred charity or charities which will receive the proceeds for the sale of the donation, pictures of the item, location of the item or service, and any other information which may be necessary or convenient for the sale of the donation. The donation management module 310 also assigns or associates each donation with at least one charity, preferably the donor's selected charity or charities. This way, when each donation is sold, the proceeds are easily transferred to the relevant charity. The donation management module 310 also manages and presents the web page detailing all the available donations for sale across the online system. To present this web page, the donation management module 310 retrieves all available donations still up for sale from database module 300 and presents these to a potential buyer. Of course, this presentation may also list not just the donations but their prices, their associated charities, their donors, and any description which may help the potential buyer make a decision to purchase one of the donations. Preferably, the donation management module 310 also provides a user of the online system with a search capability to search the database for data regarding donations both past and present. The search capability may perform searches based on keywords, categories, prices, location, buyers, charities associated with the donations, and, with the donors' agreement, donors. Thus, users may be provided with the capability to search which donation was donated by whom, who purchased it, for how much, and which charity received the relevant funds. A search result screen may present the results in any order desired by the user. As an example, the results may be ordered by charity, date, price (ascending or descending), donation name/title, location of item, or any other ordering criterion.

A further module for the system is the buyer management module 320. The buyer management module 320 manages the buyers registered with the online system. As such, the module 320 can provide buyers with their specific profile, including what donations they have purchased, how much they paid, and which charities received the proceeds. The module 320 can also provide buyers with access to their profile so that they can change their contact information, their preferred methods of payment, as well as other information relating to their account. The buyer management module 320 also provides the buyer with the capability to post a desired item or service. Donors can then see what a specific buyer desires and, if the donor is inclined, the donor can list that desired item or service for sale. The buyer may also indicate a desired charity so that the buyer's funds are routed to that charity if the donor does not object.

A donor management module 330 is also present in the online system. The donor management module 330 allows each registered donor to review and edit his or her registered account on the online system. Each donor can review and/or change his contact information, preferred charities, as well as preferred methods of shipping or delivery for donations. Furthermore, the module 330 can provide each donor with a history of his or her donations, including the description of each donation, the asking price and the final price for each donation, the charity that received the proceeds, and, for convenience, a copy of the receipt for each completed donation. The donor management module 330 can also provide the donor with the capability to remove, withdraw, or de-list a donation. Such a move edits the database and removes the donation from the available donations for sale. The donor management module 330 also allows a donor the ability to promote their item to the world wide web via a unique URL string for every individual item they are donating, such that posting to emails, social media channels and other promotion means are available to the donor. The donor management module 330 may be accessed by the donor using his or her mobile device using the above-noted mobile application.

The charity management module 340 allows charities registered with the online system to manage their account on the system. Not only that, the module 340 also allows charities to make changes to their web pages or web portals on the online system. Through the module 340, registered charity organizations can launch fund drives, edit the look, feel, and content of their web page on the system, contact their donors, adjust their bank account information to ensure funds from the sale of donations are properly transferred, as well as manage what buyers and donors see on their web portal. The module 340 also allows the charity to control what donations are to be associated with that charity. The module 340 gives the charity the ability to refuse donations which they may deem inappropriate or undesirable. As an example, material that might be considered offensive or inappropriate but which has been donated by a donor can be rejected by the charity using this module.

Another aspect of the module 340 is that the module can provide users (whether they are charities, buyers, or donors) with the ability to see a listing of available donations for that charity. Thus, a buyer who wishes to purchase a donation associated with a specific charity can do so by first requesting all donations available for sale for that specific charity.

A further module in the system is the payment management module 350. The payment management module 350 redirects the buyer to a payment processor entity when the buyer is ready to pay for the donation being sold. The module 350 also communicates with the payment processor entity and receives the communication that the buyer has made payment for the donation. Note that the communication from the payment processor entity may be as simple as an email. Once the communication that the buyer has paid, the module 350 can automatically send a communication to the donor that payment has been made and that the donor can proceed with delivery of the donation just sold. A further communication from buyer can confirm delivery of the donation. Once delivery has been confirmed, the module 350 can issue a receipt to the donor with the receipt being delivered by email or regular mail on behalf of the charity. Alternatively, the charity itself, after receiving data from the system, may issue the receipt itself to the donor. Finally, the payment management module 350 can also calculate the relevant deductions from the buyer's payment (e.g. for shipping, for the online system's fee for facilitating the transaction, etc.) to arrive at the final value to be transferred to the charity. When this value has been calculated, the payment management module 350 can automatically transfer this amount to the charity.

It should be noted that the payment management module 350 may also produce and send the receipts for the donations. These receipts can be sent to the donor via email or via automated regular mail or any other suitable means. Of course, as noted above, instead of sending the receipt directly from the system, the system may produce reports for the charities. The charities themselves can then send the relevant receipts to the relevant donors. For this configuration, the payment management module 350 produces the data for the reports and can send the report to the various charities.

The method steps of the invention may be embodied in sets of executable machine code stored in a variety of formats such as object code or source code. Such code is described generically herein as programming code, or a computer program for simplification. Clearly, the executable machine code may be integrated with the code of other programs, implemented as subroutines, by external program calls or by other techniques as known in the art.

The embodiments of the invention may be executed by a computer processor or similar device programmed in the manner of method steps, or may be executed by an electronic system which is provided with means for executing these steps. Similarly, an electronic memory means such computer diskettes, CD-ROMs, Random Access Memory (RAM), Read Only Memory (ROM) or similar computer software storage media known in the art, may be programmed to execute such method steps. As well, electronic signals representing these method steps may also be transmitted via a communication network.

Embodiments of the invention may be implemented in any conventional computer programming language. For example, preferred embodiments may be implemented in a procedural programming language (e.g. “C”) or an object oriented language (e.g. “C++”). Alternative embodiments of the invention may be implemented as pre-programmed hardware elements, other related components, or as a combination of hardware and software components. Embodiments can be implemented as a computer program product for use with a computer system. Such implementations may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or electrical communications lines) or a medium implemented with wireless techniques (e.g., microwave, infrared or other transmission techniques). The series of computer instructions embodies all or part of the functionality previously described herein. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink wrapped software), preloaded with a computer system (e.g., on system ROM or fixed disk), or distributed from a server over the network (e.g., the Internet or World Wide Web). Of course, some embodiments of the invention may be implemented as a combination of both software (e.g., a computer program product) and hardware. Still other embodiments of the invention may be implemented as entirely hardware, or entirely software (e.g., a computer program product).

A person understanding this invention may now conceive of alternative structures and embodiments or variations of the above all of which are intended to fall within the scope of the invention as defined in the claims that follow.

Having thus described the invention, what is claimed as new and secured by Letters Patent is:

1. A system for managing charitable donations of goods and services from a donor to a charity, the system comprising:
a donation management module for receiving and presenting information on a donation from a donor, said donation management module also being for associating said donation to a specific charity such that in the event said donation is sold to a buyer, at least a portion of proceeds from a sale of said donation is sent to said charity;
a payment management module for managing a payment from said buyer purchasing said donation, said payment management module also being for transferring said portion of proceeds to said specific charity once said donation has been received by said buyer; and
a database module for managing a database which stores information on said:
donation,
payment,
receipt,
buyer,
donor, and
said charity
wherein
said database module communicates with said donation management module and said payment management module to send and receive said information;
said donation comprises at least one of: goods and services;
said system is deployed on at least one computer server.

2. A system according to claim 1 further comprising:
a charity management module for managing a specific charity's account on said system, said charity management module also being for presenting information on said specific charity through a web portal.

3. A system according to claim 1 wherein said donation management module also presents to potential buyers all donations available for purchase, information regarding said all donations available for purchase being retrieved from said database.

4. A system according to claim 1 wherein said receipt for said donation is a tax receipt such that at least a portion of a value of said donation is tax deductible for said donor.

5. A system according to claim 1 wherein said payment management module only sends said receipt to said donor after an indication that said buyer has received said donation

6. A system according to claim 1 wherein said information on a donation from a donor includes an identification of said donor's preferred charity such that said donation is associated with said preferred charity.

7. A system according to claim 1 wherein said payment management module redirects said buyer to a payment processor entity when said buyer is ready to pay for said donation.

8. A system according to claim 7 wherein said payment processor entity transfers said buyer's payment to an account for an operator of said system after said buyer has paid.

9. A system according to claim 1 wherein said payment management module is further for sending said donor a receipt for said donation.

10. A system according to claim 1 wherein said payment management module is further for sending data to said charity so that said charity can issue a receipt to said donor for said donation.

11. A method for managing charitable donations of goods and services from a donor to a charity organization, the method comprising:
a) receiving information from a donor regarding a donation;
b) associating said donation with said charity organization;
c) posting said information regarding said donation to a web portal such that said donation is available for purchase;
d) receiving an offer from a buyer to purchase said donation from said donor;
e) receiving payment for said donation;
f) transferring at least a portion of proceeds to said charity once said donation has been received by said buyer;
g) sending said donor a receipt for said donation.

12. A method according to claim 11 wherein for step b), said charity organization is a preferred charity organization noted in said information from said donor.

13. A method according to claim 11 wherein, for step c), said web portal is associated with said charity organization.

14. A method according to claim 11 wherein, for step c), said web portal displays all donations available for purchase.

15. A method according to claim 11 wherein said payment is received from a payment processor entity, said payment processor entity receiving funds from said buyer.

16. A method according to claim 11 wherein said receipt for said donation is a tax receipt such that at least a portion of a value of said donation is tax deductible for said donor.

17. Computer readable media having encoded thereon computer executable instructions which, when executed, implements a method for managing charitable donations of goods and services from a donor to a charity organization, the method comprising:
a) receiving information from a donor regarding a donation;
b) associating said donation with said charity organization;
c) posting said information regarding said donation to a web portal such that said donation is available for purchase;
d) receiving an offer from a buyer to purchase said donation from said donor;
e) receiving payment for said donation;
f) transferring at least a portion of proceeds to said charity once said donation has been received by said buyer.
